(19) United States
(12) Patent Application Publication
(10) Pub. No.: US 2022/0266205 A1
(43) Pub. Date: Aug. 25, 2022

(54) ACTIVE PHOSPHOLIPID MEMBRANE AND RELATED PRODUCTION PROCESS

(71) Applicant: Biomimesi SRL, Catanzaro (IT)

(72) Inventors: Paolo SINOPOLI, Catanzaro (IT); Roberto PUGLIESE, Vercelli (IT); Daniele CIPRIANI, Roma (IT)

(21) Appl. No.: 17/631,516

(22) PCT Filed: Jul. 30, 2020
(86) PCT No.: PCT/IB2020/057186

§ 371 Date: Jan. 31, 2022

(30) Foreign Application Priority Data
Aug. 1, 2019 (IT) 102019000013758

(51) Int. Cl. B01D 69/10; B01D 69/14; B01D 69/12; B01D 71/74

(52) U.S. Cl. CPC B01D 69/10; B01D 69/144; B01D 69/12; B01D 71/74

(57) ABSTRACT

Active phospholipidic membrane (200) comprising: —a double phospholipidic layer; —at least a support (201) for supporting the double phospholipidic layer thus improving the resistance of the active phospholipidic membrane (200); —a plurality of monoclonal antibodies (202) bonded to the support (201); —a plurality of predetermined molecules (203) bound to the monoclonal antibodies (202) at a transmembrane level. Said supports (201) comprises a first substrate comprising the monoclonal antibodies (202) and a second substrate comprising the double phospholipidic layer.

The present invention relates to an active phospholipid membrane.

In addition, the present invention relates to a process of producing an active phospholipid membrane.

In particular, the present invention relates to a membrane of the type having a double layer of active phospholipid membranes, activated by the insertion of specific and transmembrane molecules, and to the relative production process.

As it is known, active membranes are currently used in many technical fields. Some of the main fields of application are, for example, the energy sector, for which semi—permeable membranes activated by specific molecules are produced or the biomedical sector.

In the technical field of accumulators, for example, chemical accumulators are traditionally known such as lithium-ion batteries that have a high density of charge and are not subject to the memory effect, or even silver-zinc batteries that have the density of energy higher but excessive production costs. Bio-generators that use cell cultures to produce electricity are being tested recently.

The technology of the ATP-dependent generators/accumulators is based on the idea of using potential differences derived from the molecular activity of cell membrane proteins. To develop ATP-dependent generators/accumulators, it is therefore necessary to build a series of fundamental structures or cells, contained in a double phospholipid membrane or of equally efficient material, which allow the localization of the cells and the development of the aforementioned molecular activity.

An example of electrochemical cells which exploit the molecular activity of specific cell cultures is described in the patent US2010/178592, which concerns a device comprising an envelope and an artificial biomimetic membrane arranged inside the envelope to form two distinct chambers. Each chamber encloses a liquid of a certain composition, and biomimetic artificial membrane comprises a semi-permeable membrane for supporting a lipid membrane, comprising a plurality of lipid molecules arranged in one layer and comprising at least one transport protein, suitable for transport of ions and/or liquid molecules between the two chambers.

A further known membrane is described in the patent US2007116610. In particular, biological functional synthetic composite membranes comprising phospholipids, proteins and porous substrates or membranes are described. The lipid bilayers are formed on porous polycarbonate membranes, polyethylene terephthalate acid and poly lactic acid (PLLA) and in holes drilled with laser in a plate made of plastic material.

Among the currently known membrane production processes the following are mostly used:
Fusion of vesicles;
Combination of the Langmuir-Blodgett technique with the vesicle fusion technique. In the case of membranes equipped with a substrate that acts as a support material, some known supports are:
Fused silica
Borosilicate glass
Not at all
Oxidized silicon
TiO2 in thin films
Indium tin oxide
Gold
Silver
Platinum.

Methods for producing active membranes such as dip pen nanolithography or DPN are also known.

However, although useful in the synthesis of active membranes, these methods have the main limitations of the cost of materials and the complexity of the production procedures.

Furthermore, one of the problems of the known production techniques is the difficulty of guaranteeing the maximum density of active molecules per phospholipidic surface.

Furthermore, the active membranes and the relative production processes currently known do not allow to predict and determine the selectivity or density of molecules linked to it. In fact, the currently known active membranes and the relative production processes do not allow to determine the presence or absence of a specific trans-membrane molecule, or even to determine to a certain extent the representativeness in terms of density per unit of square surface a to certain molecule.

Scope of the present invention is to provide a phospholipid active membrane and a relative production process, which ensures a specific density of transmembrane molecules per unit area.

A further object of the present invention is to provide a production process of a double layer of active phospholipid membranes, which is technically easy, effective and efficient, and having, therefore, features such as to exceed the limits which still affect the current process of production of active membranes with reference to the prior art.

According to the present invention, an active phospholipid membrane is provided, as defined in claim 1.

According to the present invention, a process for the production of an active phospholipid membrane is provided, as defined in claim 4.

For a better understanding of the present invention, a preferred embodiment is now described, purely by way of non-limiting example, with reference to the attached drawings, in which:

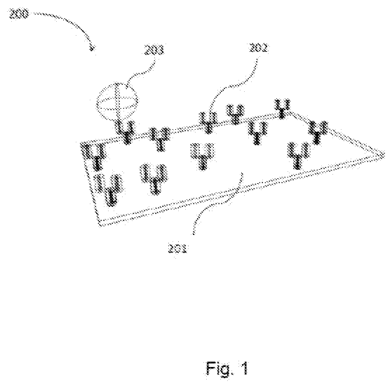

FIG. 1 shows a scheme of an active phospholipid membrane, according to the present invention;

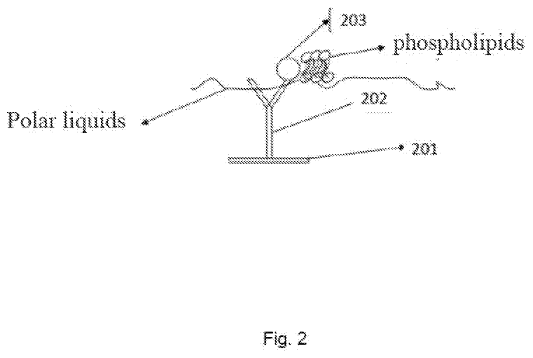

FIG. 2 shows a further scheme of an active phospholipid membrane, according to the present invention;

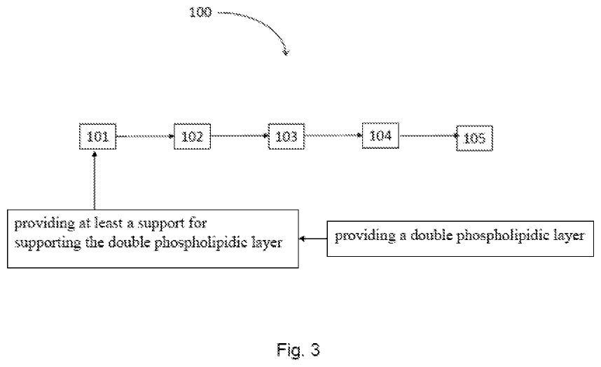

FIG. 3 shows a process for the production of an active phospholipid membrane, according to the invention.

With reference to these figures and, in particular, to FIG. 1, an active phospholipid membrane is shown, according to the invention.

In the following, we mean by active membrane a membrane made active by means of biological molecules capable, for example, of producing electricity through an alternation of polarization and depolarization.

In particular, the active phospholipid membrane 200 according to the invention comprises:
double phospholipidic layer;
At least one support 201 or substrate to improve the resistance of the active membrane, supporting the double phospholipidic layer;
a plurality of monoclonal antibodies 202 bonded to the support 201 and selected in function of the molecules that have to be inserted in the membrane 200;
Predetermined molecules 203 bonded to the monoclonal antibodies.

According to an aspect of the invention, the active phospholipid membrane 200 is inserted in a support matrix preferably constituted by a gelling agent such as the agar. The active phospholipid membrane 200, in this case a liquid containing agar is immersed, which at the end of the gelation process provides mechanical support to the structure of the membrane itself.

In this way, advantageously, the active phospholipid membrane is stabilized and easily transportable.

According to an aspect of the invention, the support to which antibodies are bound can preferably be made of PVC, cellulose nitrate or polycarbonate.

The active phospholipidic membrane 200 comprises a plurality of supports 201, or substrates, preferably a first substrate and a second substrate. The following steps take place:
Monoclonal antibodies are fixed on a first substrate;
Link between the molecules to be inserted at the trans membrane level and the monoclonal antibodies fixed on the first substrate;
deposition of phospholipids on the second substrate;
the first substrate with monoclonal antibodies bound and molecules that will be inserted at the trans membrane level settles on the second substrate creating a double or phospholipidic layer with a series of trans membrane molecules linked in turn to monoclonal antibodies. This structure provides that permeable supports are present at the level of the two outer surfaces.

As shown in FIG. 3, a process 100 of production of an active phospholipid membrane comprises the following steps:

of providing a double phospholipidic layer;

of providing at least a support for supporting the double phospholipidic layer;

101 of selecting a monoclonal antibody specific for the molecule to be inserted in the phospholipid double layer;

102 of attaching the monoclonal antibodies selected in the previous step to a support or substrate;

103 of promoting the bond between the monoclonal antibodies fixed to the support with a predetermined molecule towards which they have a specific affinity;

104 of inserting into the system obtained in the preceding phases and consisting of a monoclonal antibody—antigen substrate—a predetermined quantity of polar liquid capable of allowing, in a subsequent phase 105, the assembly of the phospholipids in a double layer which includes the molecules bound by the antibodies;

105 of adding phospholipids which assemble in a membrane at the level of the molecules bound by the antibodies, thanks to the presence of the polar liquid inserted in step 104.

The monoclonal antibody is selected in such a way that it binds the molecule but does not interfere functionally with its activity.

According to an aspect of the invention, the support or substrate on which the monoclonal antibodies are fixed in step 102 is constituted by a layer of PVC or cellulose nitrate.

According to an aspect of the invention, a double phospholipid layer is formed above the polar liquid in the step 105, the level here is accurately predetermined, the height of the molecules fixed by the monoclonal antibodies which will then be included at the trans-membrane level.

Advantageously, the process of producing an active phospholipid membrane according to the invention allows to obtain activated membranes by the inclusion of molecules that perform a desired function, and to obtain an active membrane easily manipulable thanks to mechanical substrate support.

According to an aspect of the invention, the step 101 is preceded by a phase of selection and synthesis of the molecules to be inserted at the trans-membrane level, by means of the DNA recombination technique.

The monoclonal antibodies selected in step 101 will bind the molecules that have to be inserted at the transmembrane level but, advantageously, they do not influence the function of the same molecules. Consequently, the link between the monoclonal antibody and the molecule must not take place at the level of the active site of the molecule or at the level of a portion of it that can alter its functionality.

According to an aspect of the invention, at the end of the active membrane synthesis, according to the mentioned steps, it is possible to maintain or break the link between the antibody and the last sub unit inserted at the trans membrane level.

The industrial applications of the active phospholipid membrane and of the related production process according to the invention are for example the energy use, in generators, as well as in vehicles and electrical systems useful in daily life, or biomedical, such as in systems of filters to be used in the field of dialysis, in PM devices, in aortic counter-pusters etc.

A further industrial application of the phospholipid membrane according to the invention is the extraction of ATP from organic waste.

The active phospholipid membrane according to the invention allows to obtain the maximum density of the active molecules and their precise orientation per unit of phospholipidic surface.

The active phospholipid membrane according to the invention, thanks to the activation due to the use of specific molecules, allows it to be used for example in the production of electricity in systems:
based on channels of the sodium sensible to the electric voltage;
based on channels of the potassium sensible to the electric voltage;
based on channels of the ADP-ATP translocases;
based on sodium-potassium pumps;
based on funny channels.

In addition to the molecules listed above, the present invention is applicable to additional and specific molecules for the preferred industrial application.

Advantageously, the production process according to the invention allows to obtain in an efficient and practical way active phospholipidic membranes which are easily manageable and mechanically resistant.

Furthermore, advantageously, the production process according to the invention allows to obtain the maximum density of active molecules per unit of phospholipidic surface.

Furthermore, the production process according to the invention is advantageously versatile.

Therefore, the production process according to the invention is simply and easily usable.

Finally, it is clear that the active phospholipid membrane and the relative production process here described and illustrated can be subject to modifications and variations without thereby abandoning the scope of the present invention, as defined in the appended claims.

1. Active phospholipidic membrane (200) comprising:
a double phospholipidic layer;
at least a first and second substrate (201) for supporting the double phospholipidic layer thus improving the resistance of the active phospholipidic membrane (200);
a plurality of monoclonal antibodies (202) bonded to the first substrate (201);
a plurality of predetermined transmembrane molecules (203) bound to the monoclonal antibodies at transmembrane (202);
wherein the plurality of predetermined molecules (203) are linked to the monoclonal antibodies at the trans membrane level and the plurality of predetermined molecules (203) are settled on the second substrate creating a double phospholipidic layer with a series of predetermined transmembrane molecules (203) at transmembrane level linked in turn to the monoclonal antibodies, and wherein the first and second substrate are permeable and are present at the level of the two outer surfaces of the membrane.

2. Active phospholipidic membrane (200) according to claim 1, characterized in that said support (201) is made in cellulose nitrate or polycarbonate and the membrane (200) is inserted into a support matrix comprising a gelling agent.

3. Active phospholipidic membrane (200) according to claim 1, characterized in that said support (201) is made in cellulose nitrate or polycarbonate.

4. Process (100) for the production of an active phospholipidic membrane according to one of the preceding claims, comprising the steps of:
providing phospholipids to form a double phospholipidic layer;
providing at least a first and a second substrate on which the double phospholipidic layer can be deposited;
selecting and synthesizing predetermined transmembrane molecules to be inserted in the double phospholipidic layer at a transmembrane level, using recombinant DNA technique;
a step (101) of selecting a plurality of predetermined monoclonal antibodies for the predetermined molecules to be inserted into the double phospholipid layer deposited on the second substrate;
a step (102) of binding the selected monoclonal antibodies to the first substrate;
a step (103) of fixing the monoclonal antibodies to the first substrate and the double phospholipidic layer and to the second substrate;
a step (104) of inserting a predetermined quantity of polar liquid able to allow, in a subsequent step (105), the assembly of phospholipids in a double layer which includes the predetermined transmembrane molecules bound by antibodies;
a step (105) of adding phospholipids to be assembled in a membrane at the level of the predetermined transmembrane molecules bound by antibodies, by means of the polar liquid inserted in step (104);
a step of immersing an active phospholipid membrane (200) in a liquid containing agar able to gel and provide mechanical support to the structure of the active phospholipid membrane (200).
